(19) United States
(12) Patent Application Publication
(10) Pub. No.: US 2015/0002338 A1
(43) Pub. Date: Jan. 1, 2015

(54) GALVANICALLY SEPARATED NON-INTERACTING ANTENNA SECTOR APPARATUS AND METHODS

(71) Applicant: Pulse Finland Oy, Kempele (FI)

(72) Inventors: Juha Lundbom, Kempele (FI); Petteri Annamaa, Oulunsalo (FI)

(21) Appl. No.: 13/928,026

(22) Filed: Jun. 26, 2013

(51) Int. Cl. H01Q 1/36

(52) U.S. Cl. CPC H01Q 1/36
USPC 343/700 MS; 29/600

(57) ABSTRACT

An antenna apparatus with isolated non-interactive sectors and methods operating and forming the same. In one embodiment, an antenna with a radiative element comprising a planar layer with multiple sectors is disclosed. The sectors are configured to be interactive or non-interactive. The interactive sectors contribute to the radiative profile of the antenna. The non-interactive sectors are galvanically isolated from the interactive sectors and do not substantially affect the radiative profile of the antenna. Region borders are present between various ones of the interacting and non-interacting sectors. These region borders provide the galvanic isolation between the interacting and non-interacting sectors. The antenna further includes feed portions coupled to the interactive sectors, thereby defining the antenna pattern. The non-interactive sectors are largely transparent to the radiative mode and thus do not substantially affect the antenna pattern.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNOLOGICAL FIELD

The present disclosure relates generally to antenna apparatus for use in electronic devices such as wireless or portable radio devices, and more particularly in one exemplary aspect to an antenna with one or more substantially non-interacting antenna sectors.

### DESCRIPTION OF RELATED TECHNOLOGY

Antennas are commonly found in most modern radio devices, such as mobile computers, mobile phones, Blackberry® devices, GPS or other navigation devices, smartphones, personal digital assistants (PDAs), or other personal communication devices (PCD). Often, these devices connect via one or more wireless data/voice technologies each requiring unique transmission characteristics. The device may reuse a single antenna over multiple air interface technologies, or may include multiple antennas, or both. Whether reused or multifold, these antennas must often facilitate the maintenance of radio connectivity over a variety of frequency ranges. Typically, these antennas comprise a radiating plane. However, in order to properly optimize the antenna for radiation/absorption at the proper frequency ranges, the shape of the radiating plane is constrained.

Furthermore, multiple antennas may need to be included in the device—each with a shape dictated by the transmission characteristics of its corresponding wireless technology. Generally, shape determinations are made independently of aesthetic concerns, because deviating from the optimal shape can be associated with a significant performance loss.

Typical prior art solutions often rely on visually obscuring the antenna to maintain aesthetic continuity, such as by disposing it within a housing or other component of the host device. However, material used to obscure the antenna (such as e.g., a metal housing component) may itself affect the performance of the antenna. Alternatively, significant deviations from the optimal shape are made, leading to undesirable effects.

Accordingly, there is a salient need for, inter alia, an improved antenna solution that allows for flexibility is aesthetic design without requiring significant performance tradeoffs.

### SUMMARY OF THE DISCLOSURE

The present disclosure satisfies the foregoing needs by providing, inter alia, an antenna apparatus with one or more non-interactive regions and methods of tuning and use.

In a first aspect, an antenna is disclosed. In one embodiment, the antenna includes: (i) a planar radiative layer, and (ii) one or more region borders. The planar radiative layer includes: (i) one or more active regions, (ii) at least one substantially inactive region. The one or more region borders are configured to galvanically isolate the at least one inactive region from the one or more active regions.

In a variant, the at least one substantially inactive region and the one or more active regions are formed from one or more materials with similar appearances.

In a second aspect of the disclosure, a method of forming an aesthetically optimized antenna is disclosed. In one embodiment, the method includes: (i) forming a radiating plane comprising a plurality of sectors, (ii) galvanically isolating each of the plurality of sectors, and (iii) forming one or more feeds.

In one variant, the plurality of sectors include one or more first sectors and one or more second sectors, the first sectors characterized by a dimension below a predetermined threshold, the second sectors characterized by the dimension above the predetermined threshold. Further, the method includes: configuring the antenna to radiate with a resonance pattern by (i) coupling the one or more feeds to the second sectors and (ii) galvanically isolating the first sectors from the one or more feeds.

In a third aspect of the disclosure, a method of tuning an antenna (e.g., to a desired resonance) is disclosed. In one embodiment, the method includes: (i) applying a signal to at least one feed, (ii) propagating the applied signal via one or more active sectors in electrical communication with the at least one feed, and (iii) propagating the applied signal through one or more inactive sectors, the inactive sectors being electrically isolated from the at least one feed and the active sectors.

In one variant, the one or more inactive sectors are configured to: (i) address one or more aesthetic aspects of the antenna, and (ii) leave a propagation mode of the antenna substantially unaffected.

In a fourth aspect of the disclosure, a method of operating an antenna apparatus is disclosed.

In a fifth aspect of the disclosure, a method of tuning an antenna apparatus to a resonance is disclosed.

In a sixth aspect of the disclosure, a method of operating, inter alia, a mobile device is disclosed.

Further features of the present disclosure, its nature and various advantages will be more apparent from the accompanying drawings and the following detailed description.

### BRIEF DESCRIPTION OF THE DRAWINGS

The features, objectives, and advantages of the various embodiments and aspects of the disclosure will become more apparent from the detailed description set forth below when taken in conjunction with the drawings, wherein:

FIG. 1 is a functional diagram detailing an exemplary configuration of an antenna with one or more non-interactive regions consistent with the present disclosure.

FIG. 1a is a functional diagram of the exemplary configuration of FIG. 1 with the antenna pattern highlighted for contrast.

FIG. 2 is a logical flow diagram depicting a generalized method for tuning an antenna consistent with the present disclosure.

FIG. 3 is a logical flow diagram illustrating a generalized method of forming an antenna with one or more non-interactive regions consistent with the present disclosure.

FIG. 4 is a planar view of an exemplary embodiment of an antenna with multiple interactive and multiple non-interactive regions consistent with the present disclosure.

All Figures disclosed herein are © Copyright 2012-2013 Pulse Finland Oy. All rights reserved.

### DETAILED DESCRIPTION OF THE EMBODIMENTS

Reference is now made to the drawings wherein like numerals refer to like parts throughout.

As used herein, the terms “antenna,” “antenna system,” “antenna assembly”, and “multi-band antenna” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “frequency range”, “frequency band”, and “frequency domain” refer without limitation to any frequency range for communicating signals. Such signals may be communicated pursuant to one or more standards or wireless air interfaces.

As used herein, the terms “portable device”, “mobile computing device”, “client device”, “portable computing device”, and “end user device” include, but are not limited to, personal computers (PCs) and minicomputers, whether desktop, laptop, or otherwise, set-top boxes, personal digital assistants (PDAs), handheld computers, personal communicators, tablet/phablet computers, portable navigation aids, J2ME equipped devices, cellular telephones, smartphones, personal integrated communication or entertainment devices, or literally any other device capable of interchanging data with a network or another device.

Furthermore, as used herein, the terms “radiator,” “radiating plane,” and “radiating element” refer without limitation to an element that can function as part of a system that receives and/or transmits radio-frequency electromagnetic radiation; e.g., an antenna.

The terms “RF feed,” “feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

As used herein, the terms “top”, “bottom”, “side”, “up”, “down”, “left”, “right”, and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB).

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, NFC/RFID, Zigbee, satellite systems such as GPS, millimeter wave or microwave systems, optical, acoustic, and infrared (i.e., IrDA).

### Overview

The present disclosure addresses the above-discussed needs by, in one exemplary embodiment, providing techniques and apparatus for non-interactive regions disposed on a radiative plane of an antenna. In the exemplary implementation, the antenna includes a one or more active regions and a plurality of non-interactive regions. The non-interactive regions provide flexibility in the selection of the overall aesthetic mode of the antenna. This is achieved by substantially decoupling the radiative profile of the antenna with its physical layout and appearance. The non-interactive regions are configured so as to avoid coupling with the radiative models) of the antenna. For example, in various implementations, the size (e.g. area, volume, length of major axes, etc.) of the non-interactive regions is selected such that they are largely transparent to the radiated mode of the antenna. Thus, the non-interactive regions may be placed with limited concern as to whether the radiative profile of the antenna is altered.

The active regions define the antenna pattern, and are coupled to feeds that supply (or accept) the signal transmitted (received) by the antenna. In various embodiments, the active and non-interactive regions are electrically isolated from one another. In one variant, the isolation is achieved by one or more insulating borders placed between the various regions.

The non-interactive regions may also be used to obscure the actual pattern of the antenna. For example, if the non-interactive regions are fashioned from a material similar in appearance (or the same material) to that of the active region, attempts to discern the pattern of the antenna by visual inspection may be frustrated. This may be useful, inter alia, in situations in which the antenna pattern conflicts with one or more aesthetic design aspects of a host (e.g., mobile) device.

### Detailed Description of Exemplary Embodiments

Detailed descriptions of the various embodiments and variants of the apparatus and methods of the disclosure are now provided. While primarily discussed in the context of wireless mobile devices, the various apparatus and methodologies discussed herein are not so limited. In fact, many of the apparatus and methodologies described herein are useful in any number of complex antennas, whether associated with mobile or fixed devices that can benefit from substantially non-interacting sector antenna methodologies and apparatus described herein.

Further, the exemplary techniques and architectures presented herein are discussed in terms of an antenna including a radiative plane or layer. However, other antenna configurations may be substituted. The principles described herein may be used with virtually any antenna configuration wherein the appearance or physical layout of antenna is not defined or fully defined by its radiative profile.

### Exemplary Antenna Apparatus

The present disclosure provides, in one salient aspect, an antenna apparatus including a radiating element with one or more substantially non-interacting sectors and methods of forming and operating the same. Specifically, in one embodiment, the aesthetic design tolerances of an antenna component in an electrical device are increased, without proportional tradeoffs in antenna performance. Thereby, the embodiment allows for increased aesthetic continuity in spatially compact host devices such as smartphones, tablets, phablets, and the like.

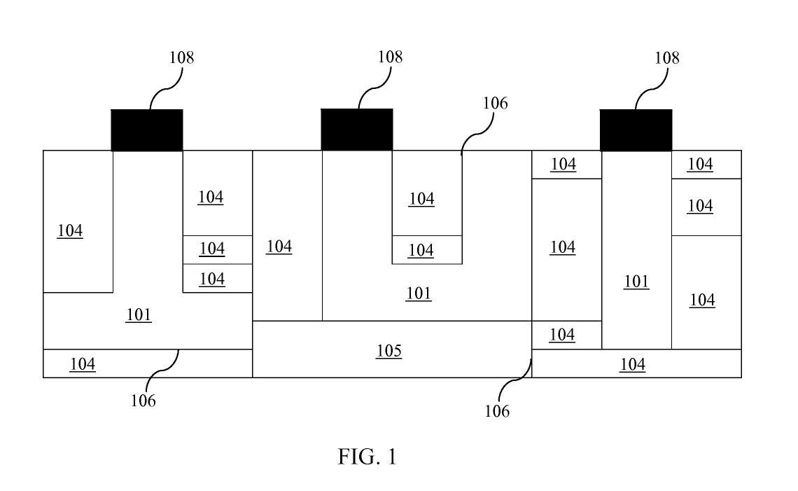

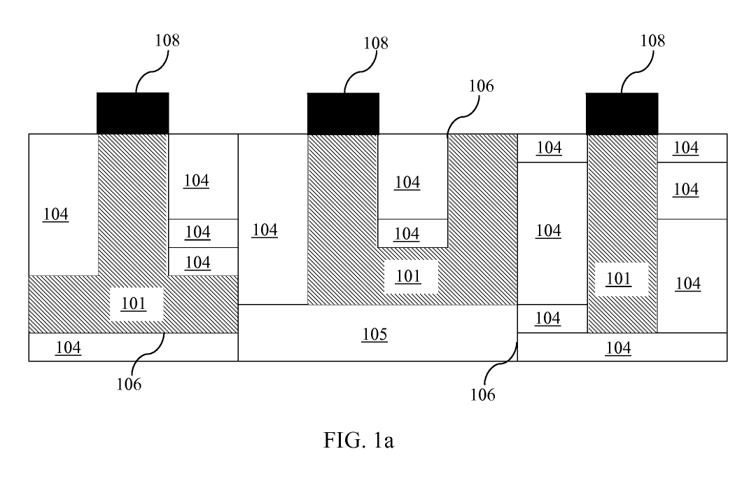

Referring now to FIG. 1, an exemplary embodiment 100 of the antenna radiative element is shown. The radiative element comprises a planar layer fashioned from a single material. The antenna may be configured to operate at various microwave or radio frequencies (e.g. 100 kHz-1 THz). In some embodiments, cellular and wireless communication bands are used (e.g. 800 MHz, 900 MHz, 1.9 GHz, 2.1 GHz, 2.4 GHz, or 5 GHz, etc.). Further, the antenna may be configured for multiband operation and configured to resonate at multiple frequencies. The planar layer is divided into sectors (102, 104, 105), which may vary in size and shape. The sectors may be configured to be interactive 102 or non-interactive 104, 105. The interactive sectors contribute to the radiative profile of the antenna. The non-interactive sectors are galvanically isolated from the interactive sectors and do not substantially affect the radiative profile of the antenna.

In some implementations, the non-interactive sectors have one or more dimensions below a predetermined threshold to minimize the effect of the non-interactive sector on the radiative profile of the antenna.

In some variants, the non-interactive sectors include a rectangular area on the planar layer with a length dimension less than a fraction of a wavelength of the highest frequency in the operative band(s) of the antenna. For example, length of the sectors may be constrained to a quarter of the wavelength or one-twentieth of the wavelength. It will be appreciated that for an arbitrarily shaped area, the constraint may apply to a maximum diameter or other defining dimension of the sector. Moreover, the size constraint may vary depending on the medium of propagation. For example, a wave traveling within a copper medium will have its size thresholds scaled by the index of copper (for a given frequency). Similarly, a wave traveling in free-space will have larger size thresholds given the relevant index of one for free-space.

Referring again to the embodiment 100 of FIG. 1, it can be seen that region borders 106 are present between various ones of the interacting and non-interacting sectors. These region borders may be configured to provide the galvanic isolation between the interacting and non-interacting sectors discussed above. In various implementations, the isolation may be provided by various electrically insulating materials such as polyethylene terephthalate (PET), polyethylene naphthalate (PEN), polyimide (PI), polycarbonate (PC), glass, etc., or by air gaps at the region borders.

The borders 106 are visibly distinct in the embodiment of FIG. 1. However, in other embodiments, the borders may comprise materials visibly similar or even identical to the material of the interacting sectors. The visibly similar material may be configured to provide the galvanic isolation, as is the case with visibly distinct borders. Thus, the visibly similar borders further obscure the layout of the antenna, while still providing functionality. The visibly similar material may be an insulating material with the same color/texture as that of the material making up the sectors. Further, visibly similar material may be a different state of the same material making up other portions of the antenna. For example, the material may be a non-conductive mesh coated in a conducting compound, and the visibly similar material may be the mesh with the compound removed.

The feeds 108 connect one or more of the interacting portions of the radiative planar element to the drive elements of the antenna allowing operation. It will be appreciated that various ones of the interactive regions 101 may galvanically isolated from each other. Further, some embodiments comprise interactive regions isolated from other such regions and the feeds (not shown). These isolated interactive regions affect the radiative profile by coupling to the radiated mode of the other interactive regions, thereby altering the final mode (e.g. frequency resonance, spatial profile, directivity, etc.) propagated by the antenna. In some variants, an isolated interactive region may include a region with a dimension longer than the wavelengths of one or more of the operative bands of the antenna. For example, an isolated interactive region may have a dimension corresponding to a multiple of a wavelength of a frequency in one of the operating bands of the antenna.

Referring now to FIG. 1a, the exemplary embodiment of the apparatus 100 of FIG. 1 is shown, with the actual antenna pattern darkened for contrast. It should be noted that the darken areas are shown as such to elucidate the antenna pattern, but are not intend to suggest or require a particular appearance of the antenna. The non-interactive 104, 105 sectors provide the antenna with a regular rectangular appearance despite the actual pattern of the antenna being irregular. From FIG. 1a, it can be seen that non-interacting sectors 105 may be larger in area than one or more of the interactive sectors. Non-interacting sectors above a given size threshold for interactivity may be sliced into smaller sub-sectors. Each of the smaller sub-sectors may itself be divided until no single contiguous region above the size threshold comprises a single sector. Thus, non-interacting regions of arbitrary size may be created from a conglomerate of sectors.

### Methods

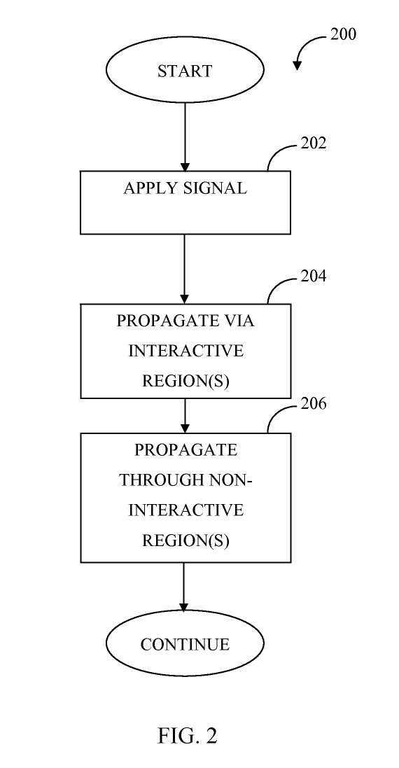

Referring now to FIG. 2, one embodiment of a generalized method 200 of tuning an antenna to a resonance mode is depicted in a logical flow diagram. At step 202 of the method 200, a signal is applied to a feed structure for the radiating plane of the antenna. The signal may include, without limitation, virtually any signal configured for propagation from a radio antenna (e.g. encoded data signals, digital or analog communications signals, voice calls, video calls, broadcasts, etc.).

At step 204, the applied signal is propagated using one or more of the interactive regions 101. The interactive regions are in signal communication with the antenna feeds. In various implementations, this communication is achieved through direct electrical contact; however in other implementations, other methods of coupling may be used between the feeds and interactive regions (e.g. inductive or capacitive techniques, etc.). The interactive regions define the radiative mode of the applied signal.

At step 206, the radiated mode propagates through one or more of the non-interactive regions 104 disposed proximate to the interactive regions 101. The non-interactive regions are configured to leave the propagating mode substantially unaffected. In various embodiments, this is achieved by configuring the non-interactive regions such that they do not couple to the radiated mode from the interactive regions. For example, as discussed above, the non-interactive regions may be broken into smaller isolated sub-sectors that are below a given size threshold. Thus, the non-interactive regions suffice to change the appearance and layout of the antenna without altering the propagated mode defined by the interactive regions.

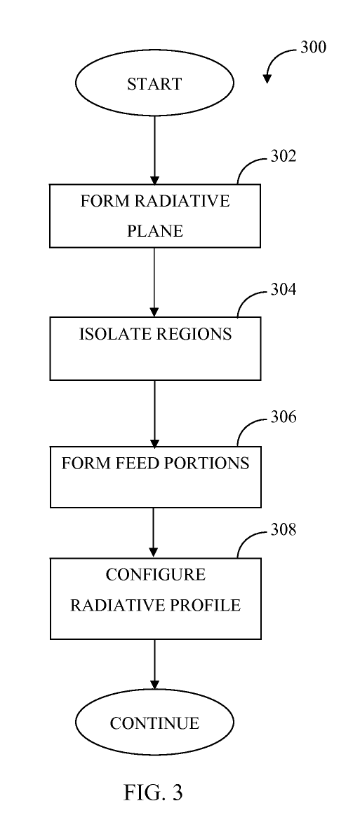

Referring now to FIG. 3, one embodiment of a generalized method 300 of fabricating an antenna is illustrated in a logical flow diagram. At step 302, the method 300 includes forming a radiative plane with multiple regions. The region may interactive or non-interactive. The two types of regions are in one variant fabricated from materials with similar appearances, so as to maintain aesthetic continuity throughout the antenna. The interactive sections are formed such that they couple with the radiative mode of the antenna and define the antenna's radiative profile. The non-interactive sections are formed such that they do not substantially couple with radiative mode of the antenna.

In various embodiments, forming the regions such that they do not couple includes ensuring the non-interactive regions are below a predetermined size threshold (e.g. volume, area, largest dimension, dimension in the direction of propagation, etc.). It will be appreciated that such non-interactive regions may adjacent (or otherwise proximate) to other such non-interacting sections, such that a contiguous non-interactive region larger that the size threshold may be formed. The interactive and non-interactive regions may be formed out of materials that are similar in appearance. In some embodiments, the regions (whether interactive or non-interactive) are formed out of the same material. The material used in fabrication of the non-interactive regions may affect the size threshold necessary for non-interaction. In some cases, the selection of material may eliminate a need for any such threshold.

At step 304, the various regions are galvanically isolated from one another. A discussed above, the galvanic isolation may be achieved through e.g., the use of the insulating region borders 106. The borders themselves may be fabricated out of materials similar in appearance to that of the regions. Thus, the physical appearance of the antenna may be substantially independent of the radiative mode.

At step 306, feed portions of the antenna are formed. The feed portions may be formed out of any of a host of materials such that signals may be reliably passed to the active regions of the antenna.

At step 308, the antenna is configured for a particular radiative profile by coupling the feed portions to the interactive regions of the antenna. The coupling between the feed portions and the interactive regions defines the propagated mode of the antenna. In some embodiments, the coupling is achieved by placing the feeds in direct electrical communication with the interactive regions. In other embodiments, the coupling is achieved indirectly through capacitive or inductive techniques.

### Example Operation

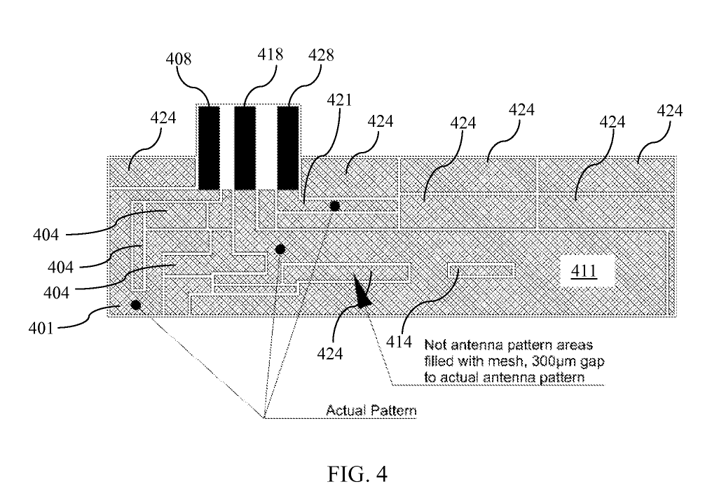

Referring now to FIG. 4 an exemplary antenna 400 with interactive 401, 411, 421 and non-interactive regions 404, 414, 424 in its radiative plane is shown. The feeds 408, 418, 428 are in direct electrical contact with the interactive regions. The antenna is configured to operate as a tri-band digital cellular antenna at 800 MHz, 1.9 GHz, and 2.1 GHz.

The inter-region borders of this embodiment are composed of an insulating polymer material. The polymer material also serves to physically hold together the pieces that make up the radiative plane.

The regions (both interactive and non-interactive) are composed of a copper (Cu) mesh with 12-μm square-shaped holes. The holes a placed in a diamond pattern (e.g., the squares are 12 μm from a corner its opposite (i.e., 8.49-μm sides)).

The non-interactive region 414 is an example of a non-interactive region which is too small to couple to any of the radiative modes of the antenna. The region merely exists as a 100-μm×30-μm gap in the actual pattern of the antenna.

The non-interactive regions 424 are examples are regions that are large enough to couple to the radiative modes of the antenna. These regions have the potential to disturb the modes at 1.9 GHz and 2.1 GHz, in particular. For clarity, these regions are shown without internal borders (so as to demarcate their full extent); however, these regions are in the illustrated embodiment broken up into small sub-regions such that they do not disturb the modes of the antenna at any of the operational frequencies.

The interactive regions 401, 411, 421 are respectively connected to the feeds 408, 418, 428 and define the output mode of the antenna. The interactive are configured to radiate according signals applied to the feeds (e.g. from a mobile wireless device).

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. An antenna comprising:
a planar radiative layer comprising:
one or more active regions;
at least one substantially inactive region; and
one or more region borders configured to galvanically isolate the at least one inactive region from the one or more active regions.

2. The antenna of claim 1, wherein the at least one substantially inactive region and the one or more active regions are formed from one or more materials with similar appearances.

3. The antenna of claim 2, wherein the one or more materials with similar appearances comprise only a single material.

4. The antenna of claim 2, wherein the one or more material with similar appearances comprise at least two materials of a single color.

5. The antenna of claim 1, wherein the borders comprise an insulating polymer material.

6. The antenna of claim 2, wherein the borders comprise a substance with a similar appearance to the one or more materials with similar appearances.

7. The antenna of claim 1, wherein the at least one inactive region comprises at least one dimension below a predetermined threshold.

8. The antenna of claim 1, further comprising one or more feeds coupled to the one or more active regions.

9. A method of forming an antenna, the method comprising:
forming a radiating plane, the radiating plane comprising a plurality of sectors, the plurality of sectors comprising one or more first sectors and one or more second sectors, the first sectors characterized by a dimension below a predetermined threshold, the second sectors characterized by the dimension above the predetermined threshold;
galvanically isolating each of the plurality of sectors;
forming one or more feeds; and
configuring the antenna to radiate with a resonance pattern by (i) coupling the one or more feeds to the second sectors and (ii) galvanically isolating the first sectors from the one or more feeds.

10. The method of claim 9, wherein the antenna is optimized in at least one aesthetic feature or aspect, and the first and second sectors are respectively formed from first and second materials, the first and second materials comprising materials that are similar in appearance to one another.

11. The method of claim 10, wherein the first and second materials comprises an identical material.

12. The method of claim 9, wherein the one or more second sectors comprise adjacent sectors so as to form a region characterized by the dimension above the predetermined threshold.

13. The method of claim 9, wherein the galvanic isolation of each of the plurality of sectors comprises forming an insulating border between each adjacent sector.

14. The method of claim 9, wherein the coupling of the one or more feeds to the second sectors comprises one or more of (i) direct electrical coupling, (ii) capacitive coupling, and (iii) inductive coupling.

15. A method of tuning an antenna to a resonance, the method comprising;
applying a signal to at least one feed;
propagating the applied signal via one or more active sectors in electrical communication with the at least one feed; and
propagating the applied signal through one or more inactive sectors, the inactive sectors electrically isolated from the at least one feed and the active sectors;
wherein the one or more inactive sectors are configured to:
comply with one or more aesthetic requirements of the antenna; and
leave a propagation mode of the antenna substantially unaffected.

16. The method claim 15, wherein the inactive sectors are fabricated from a first material similar in appearance to a second material of fabrication of the active sectors.

17. The method of claim 16, wherein the first and second materials comprise only a single material.

18. The method of claim 15, wherein polymer borders facilitate the electrical isolation of the inactive sectors from the at least one feed and the active sectors.

19. The method of claim 15, wherein the aesthetic requirement comprises obscuring a layout of the antenna.

20. The method claim 14, wherein the aesthetic requirement addressed comprises providing the antenna with a regular shape.

21. The method claim 20, wherein the regular shape comprises a rectangular shape.
